(19) United States
(12) Patent Application Publication
(10) Pub. No.: US 2003/0131710 A1
(43) Pub. Date: Jul. 17, 2003

(54) Hand exercise device

(76) Inventor: Arthur Howard Goldiner, Grover Beach, CA (US)

Correspondence Address: Theresa A. Orr, Dobrusin & Thennisch PC, Suite 311, 401 South Old Woodward Avenue, Birmingham, MI, 48009, US

(21) Appl. No.: 10/047,704

(22) Filed: Jan. 15, 2002

(51) Int. Cl. G10D 1/04

(52) U.S. Cl. 84/265

(57) ABSTRACT

The present invention provides a device for generating callused skin on a fingertip of a user while simultaneously providing an individual finger and overall hand exerciser. The device forms an exposed upper surface area having a raised ridge or a series of raised ridges extending the length of the upper surface area. Grooves transect each ridge, forming a crest extending perpendicular to the length of the ridge. A series of grooves are provided along the length of the raised ridge and the overall upper surface area simulates a string of a stringed instrument.

### TECHNICAL FIELD

The present invention relates to a device for generating callused skin on a fingertip or fingertips that typically develop as a result of playing a stringed instrument or working with stringed-oriented sporting goods and equipment.

### BACKGROUND OF THE INVENTION

Many devices are found in the prior art for teaching the playing of a stringed instrument such as a guitar, mandolin, ukulele or others. Additionally, many devices have been developed for strengthening and exercising the hand and individual fingertips of an individual for weightlifting, golf, tennis, racquetball and the playing of stringed instruments. Other devices combine the efforts of both disciplines to exercise the fingers while musically training a user in technique, dexterity, and proficiency.

However, while many of these devices are useful for musicians, none of the aforementioned training devices provide for the necessary generation of callused tissue on a player's fingertips for the successful playing of a stringed instrument on a continuous and regular basis.

### SUMMARY OF THE INVENTION

The present invention provides a device for generating callused skin on a fingertip of a user while simultaneously providing an individual finger and overall hand exerciser. The strings of an instrument are generally worked by the bare fingers and therefore, it is advantageous, indeed critical, to form calluses on the fingertip area and maintain these calluses to aid in playing. This is particularly the case for musicians and other professionals who must handle and manipulate the string material on a regular basis or otherwise need to maintain the calluses in place for continuous conditions.

The device forms an exposed upper surface area having at least one raised ridge or a series of raised ridges extending the length of the upper surface area. Grooves transect each ridge, forming a crest extending perpendicular to the length of the ridge. A series of grooves are provided along the length of the raised ridge and the overall upper surface area simulates a string of a stringed instrument.

One embodiment of the present invention is the use of the device in conjunction with a combination individual finger and hand exerciser having individually independent finger grips. The exposed upper surface area includes opposing sides extending downwardly from the upper surface area, culminating in a lip. The upper surface area, opposing sides and lip form a removable cap that may be snapped over the independent finger grips of the hand exerciser. When used as an improvement to a hand exerciser, the device may be formed in different shapes to fit over the pre-existing independent finger grips.

Generally, the device may be formed in two distinct shapes, an end shaped and an intermediate shaped cap. The upper surface area of the end shaped cap is preferably formed with a continuous radius forming one side of the upper surface leading into opposing straight sides and a straight edge opposite the radius, similar to an elongated semi-circle. The opposing sides extending downwardly from the upper surface area flow together about the radius forming a three-sided cap. The lip extends the length of the sides. This formation of the device form fits the individual independent end finger grips found on most hand exercisers and is placed over the end finger grips by sliding the cap sideways over the outer edge of the grip.

A second shape, the intermediate shaped cap, preferably has an upper surface area that is rectangular in shape and opposing sides extending downwardly from the longer edges of the rectangle, culminating in a lip on either side. Each lip extends the length of the side. This formation of the device form fits the individual independent middle finger grips found on most hand exercisers and is snap fit over the top of each middle grip.

The exposed upper surface area of any embodiment of the device may be provided with any number of simulated strings, e.g. three, four, five or six strings. The raised ridge or ridges may also be provided with any number of grooves. The device may be formed of any material such as thermoplastic or thermoset materials, and manufactured by any means appropriate to the material used, such as injection molding, pouring in thermosetting resin, or other, and is in no way limited. The shape of the caps is only limited to the shape of the individual independent finger grips to be retrofitted.

In a second preferred embodiment, the device includes the formation of a combination individual finger and hand exerciser having individual independent finger exercisers with an exposed upper surface area having a raised ridge or a series of raised ridges extending the length of the upper surface area. Grooves transect each ridge, forming a crest extending perpendicular to the length of the ridge. A series of grooves are provided along the length of the raised ridge and the overall upper surface area simulates a string of a stringed instrument. The device incorporates the simulated string in the contact area for a fingertip on the exerciser.

A third embodiment of the present invention is a hand held device that is preferably a grip engagable with and manipulated by the palm of a user's hand. This grip includes an exposed upper surface area having at least one raised ridge or a series of raised ridges extending the length of the upper surface area. Grooves transect each ridge, forming a crest extending perpendicular to the length of the ridge. A series of grooves are provided along the length of the raised ridge and the overall upper surface area simulates a string of a stringed instrument.

A fourth embodiment of the present invention is a hand held device that simulates a guitar pick. Like the previous embodiments described above, the pick-like structure includes an exposed upper surface area having at least one raised ridge or a series of raised ridges extending the length of the upper surface area. Grooves transect each ridge, forming a crest extending perpendicular to the length of the ridge. A series of grooves are provided along the length of the raised ridge and the overall upper surface area simulates a string of a stringed instrument.

As set forth above, the exposed upper surface area of any embodiment of the device may be provided with any number of simulated strings, e.g. three, four, five or six strings or more. The raised ridge or ridges may also be provided with any number of grooves. The device may be formed of any material such as thermoplastic or thermoset materials, and manufactured by any means appropriate to the material used, such as injection molding, pouring in thermosetting resin, or other, and is in no way limited. The shape of the contact area is only limited to the shape desired when considering the overall shape of the hand exerciser device.

Along with improving strength to the hand and fingertips, the device of the present invention provides the added benefit of working the fingertips to produce and maintain callusing that is typically the end result of stringed instrument play. The simulation of a string upon the exposed upper surface area of the contact area for a fingertip enhances the usefulness of a hand exerciser by simultaneously strengthening and toughening the fingertips.

The method for forming callused skin on a fingertip includes providing a hand exerciser having individual independent finger grips with a fingertip contact area having an exposed upper surface area with raised ridges and grooves transecting the ridges to simulate a string of a stringed instrument. The user depresses at least one fingertip against the upper surface area when exercising the hand or individual fingers. The simulated string creates a ridged area on a fingertip that generates a callused area on the fingertip from repeated depression of the upper surface area. Continuously using the hand exerciser and, specifically, depressing the fingertip contact area maintains the formed callus.

These and other objects of the present invention will become apparent upon reading the following detailed description in combination with the accompanying drawings, which depict systems and components that can be used alone or in combination with each other in accordance with the present invention.

### BRIEF DESCRIPTION OF THE DRAWINGS

FIG. 1 illustrates a plan view of a preferred embodiment of the present invention;

FIG. 2 illustrates a top view of the upper surface area of an end shaped and intermediate shaped cap of the present invention;

FIG. 3 illustrates a partial perspective view of a raised ridge with transecting grooves along the upper surface area;

FIG. 4 illustrates a side view of an end shaped and intermediate shaped cap of the present invention;

FIG. 5 illustrates a second preferred embodiment of the invention and the method of using the device;

FIGS. 6A-E illustrate a third preferred embodiment of the invention; and

FIGS. 7A-C illustrate a fourth preferred embodiment of the invention.

### DESCRIPTION OF THE PREFERRED EMBODIMENT

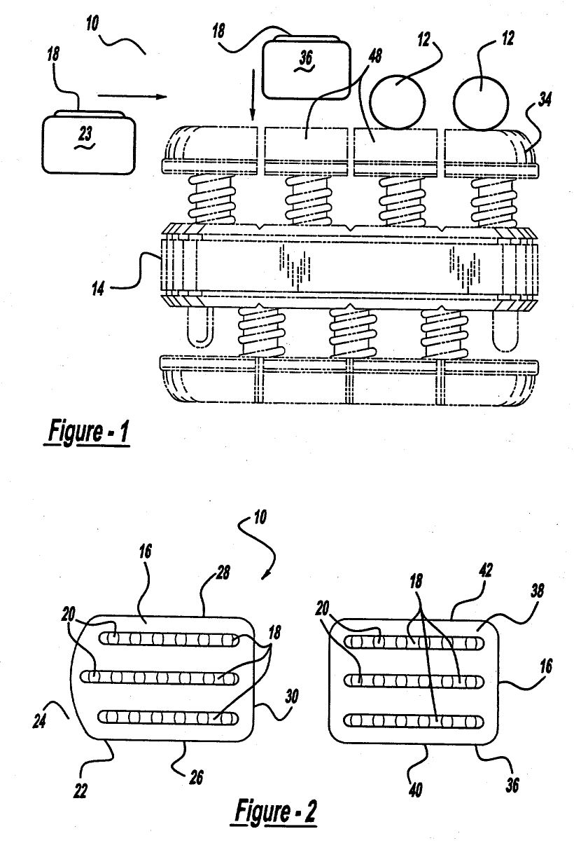

FIGS. 1 through 4 illustrate a first preferred embodiment of the invention and includes a device 10 for generating callused skin on a fingertip 12 for use in conjunction with an individual finger and overall hand exerciser 14.

With reference to FIG. 2, an exposed upper surface area 16 is there shown having a raised ridge or a series of raised ridges 18 extending the length of the upper surface area 16. Grooves 20 transect each ridge 18, forming a crest extending perpendicular to the length of the ridge 18. A series of grooves 20 are provided along the length of the raised ridge 18 and the overall upper surface area 16 simulates a string of a stringed instrument.

The device 10 may be formed in two distinct shapes, an end shaped and an intermediate shaped cap as best shown in FIGS. 1,2 and 4. The upper surface area 16 of the end shaped cap 22 is preferably formed with a continuous radius 24 forming one side of the upper surface 16 leading into opposing straight sides 26,28 and a straight edge 30 opposite the radius 24, similar to an elongated semi-circle. The opposing sides 26,28 extending downwardly from the upper surface area 16 flow together about the radius 24 forming a three-sided cap 22 as best shown in FIG. 4. A lip 32 extends the length of the sides 26,28. This formation of the device 10 form fits the individual independent end finger grips of the hand exerciser 14 and is placed over the pre-existing end finger grips 34 by sliding the cap 22 sideways over the outer edge of the grip 34 as shown in FIG. 1.

A second shape, the intermediate shaped cap 36, preferably has an upper surface area 38 that is rectangular in shape and opposing sides 40,42 extending downwardly from the longer edges of the rectangle, culminating in a lip 44,46 on either side. Each lip 44,46 extends the length of the corresponding side 40,42. This formation of the device 10 form fits the individual independent middle finger grips 48 of the hand exerciser 14 and is snap fit over the top of each pre-existing middle finger grip 48 as shown in FIG. 1.

The exposed upper surface area of any embodiment of the device may be provided with any number of simulated strings, e.g. three, four, five or six strings, or more. The raised ridge or ridges may also be provided with any number of grooves. The device may be formed of any material such as thermoplastic or thermoset materials, and manufactured by any means appropriate to the material used, such as injection molding, pouring in thermosetting resin, or other, and is in no way limited. The shape of the caps is only limited to the shape of the individual independent finger grips to be retrofitted.

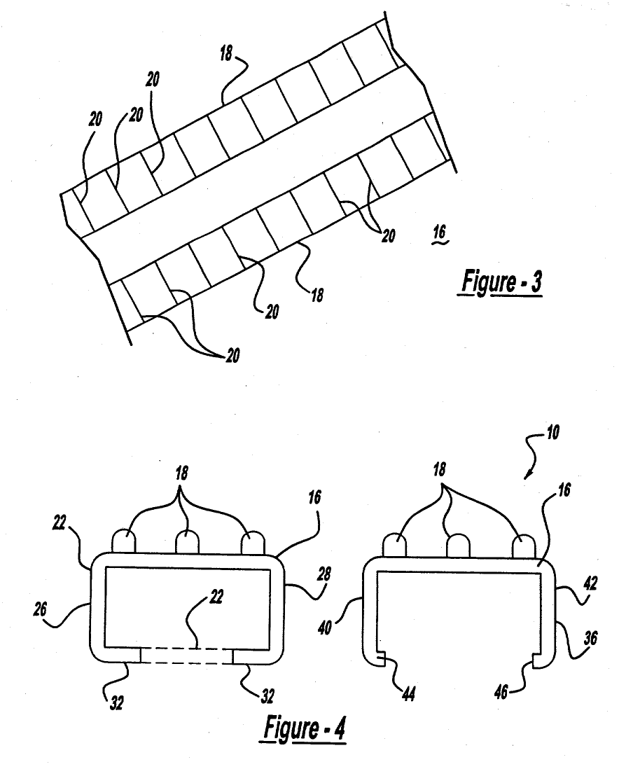

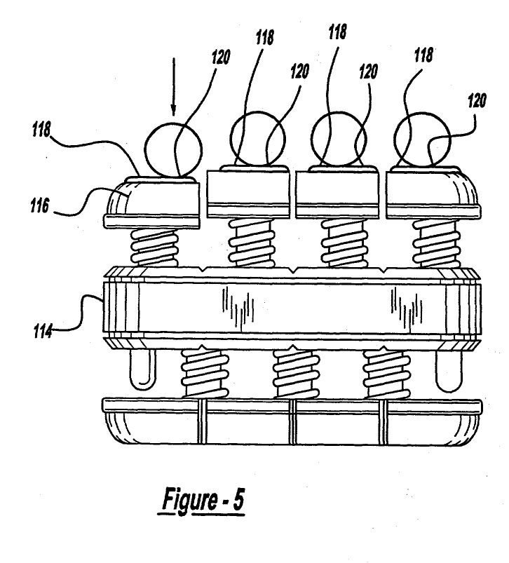

FIG. 5 illustrates a second preferred embodiment, in which the device 10 includes the formation of a combination individual finger and hand exerciser 114 having individual independent finger exercisers 116 with an exposed upper surface area 118 having a raised ridge or a series of raised ridges 120 extending the length of the upper surface area 118. With reference to FIG. 3, grooves 20 transect each ridge 120, forming a crest extending perpendicular to the length of the ridge 120. A series of grooves 20 are provided along the length of the raised ridge 120 and the overall upper surface area 118 simulates a string of a stringed instrument. The device 10 incorporates the simulated string in the contact area for a fingertip on the exerciser as best shown in FIG. 5.

As set forth above, the exposed upper surface area of any embodiment of the device may be provided with any number of simulated strings, e.g. three, four, five or six strings, or more. The raised ridge or ridges may also be provided with any number of grooves. The device may be formed of any material such as thermoplastic or thermoset materials, and manufactured by any means appropriate to the material used, such as injection molding, pouring in thermosetting resin, or other, and is in no way limited. The shape of the contact area is only limited to the shape desired when considering the overall shape of the hand exerciser device.

With reference to FIGS. 1 and 5, the method for forming callused skin on a fingertip is there shown and includes providing a hand exerciser 14,114 having individual independent finger grips 22,36,116 with a fingertip contact area having an exposed upper surface area 16,118 with raised ridges 18,120 and grooves 18 (see FIG. 2) transecting the ridges 18,120 to simulate a string of a stringed instrument. The user depresses at least one fingertip against the upper surface area when exercising the hand or individual fingers, as shown by the downward arrow in FIGS. 1 and 5. The simulated string creates a ridged area on a fingertip that generates a callused area on the fingertip from repeated depression of the upper surface area. Continuously using the hand exerciser and, specifically, depressing the fingertip contact area maintains the formed callus.

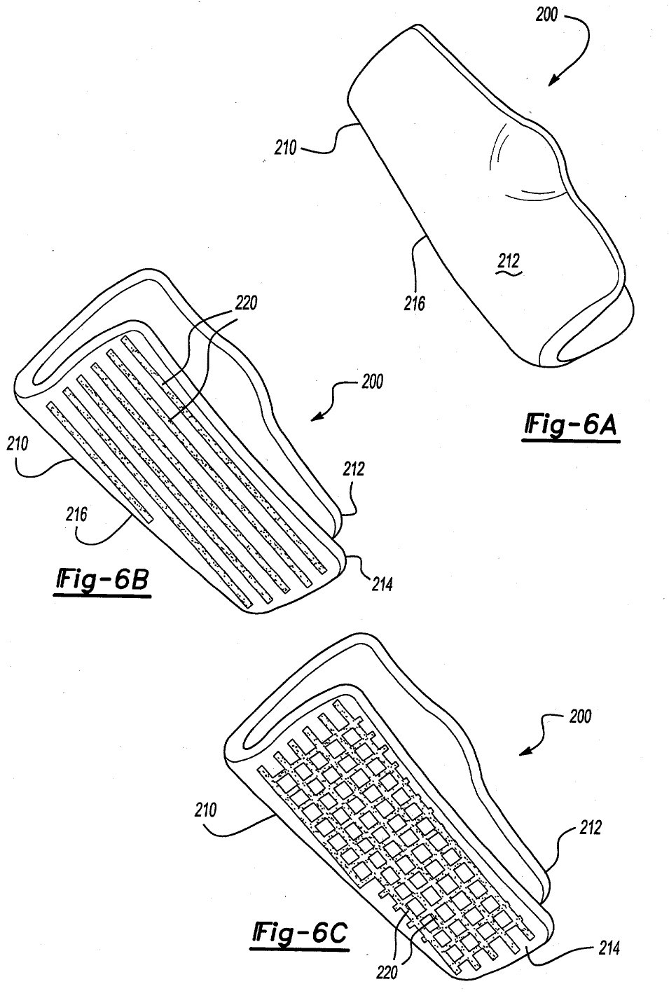

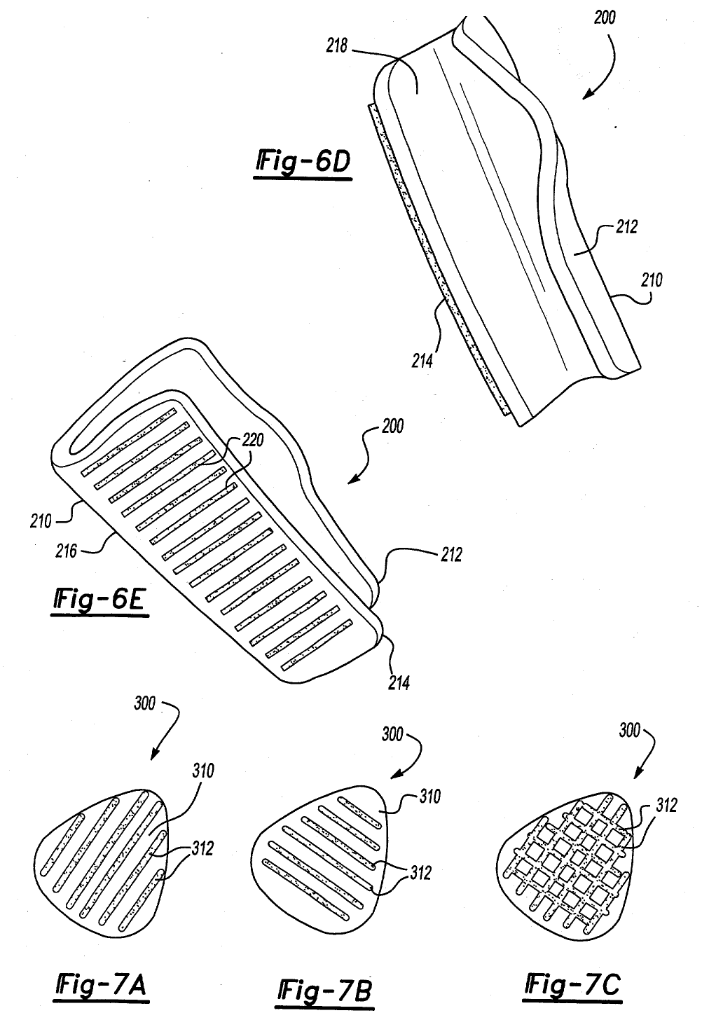

FIGS. 6A-E illustrate a third embodiment of the present invention, in which the device is a hand held device 200 that is preferably a grip 210 engagable with and manipulated by the palm of a user's hand. The hand held device is preferably formed with a smooth face 212 that rests against the palm of the user's hand. This grip 210 also includes an exposed upper surface area face 214 joined to and opposing the smooth face 212 by a rounded edge 216. The interior surface area 218 may be smooth or ridged. The upper surface area 214 includes at least one raised ridge 220 or a series of raised ridges extending the length and width of the upper surface area 214. As illustrated in FIG. 3, grooves transect each ridge, forming a crest extending perpendicular to the length of the ridge. A series of grooves are provided along the length of the raised ridge and the overall upper surface area 214 simulates a string of a stringed instrument. The grip or the rounded edge may be formed of flexible material to aid increasing hand strength while simultaneously callusing the finger tips.

FIGS. 7A-C illustrate a fourth embodiment of the present invention, in which the device is a hand held device 300 that simulates a guitar pick. Like the previous embodiments described above, the pick-like structure 300 includes an exposed upper surface area 310 having at least one raised ridge 312 or a series of raised ridges extending the length of the upper surface area. As illustrated in FIG. 3, grooves transect each ridge, forming a crest extending perpendicular to the length of the ridge. A series of grooves are provided along the length of the raised ridge and the overall upper surface area simulates a string of a stringed instrument.

It should be understood that the invention is not limited to the exact embodiment or construction that has been illustrated and described but that various changes may be made without departing from the spirit and the scope of the invention.

1. A device for generating callused skin on a fingertip, said device comprising:
an exposed upper surface area having a raised ridge extending the length of said upper surface area, said ridge further comprising a groove transecting said ridge and forming a crest extending perpendicular to the length of said ridge and simulating a string of a stringed instrument.

2. The device of claim 1, and further comprising opposing sides extending downwardly from said upper surface area, said opposing sides culminating in a lip, said upper surface area, opposing sides and lip forming a removable cap for releasably attaching said device to a finger exerciser, said cap forming the contact area for a fingertip.

3. The device of claim 1, and further comprising opposing sides extending downwardly from said upper surface area forming a cap, said cap forming the contact area for a fingertip of said device.

4. The device of claim 3, wherein said device is a combination individual finger and hand exerciser.

5. A device for generating callused skin on a fingertip for use in conjunction with a combination individual finger and hand exerciser having individually independent finger grips, said device comprising:
an exposed upper surface area having at least one raised ridge extending the length of said upper surface area, said ridge further comprising a groove transecting the width of said ridge and forming a crest extending perpendicular to the length of said ridge and simulating a string of a stringed instrument.

6. The device of claim 5, and further comprising opposing sides extending downwardly from said upper surface area, said opposing sides culminating in a lip, said upper surface area, opposing sides and lip forming a removable cap for releasably attaching said device to said exerciser, said cap forming the contact area for a fingertip.

7. The device of claim 5, and further comprising opposing sides extending downwardly from said upper surface area forming a cap, said cap forming the contact area for a fingertip of said combination individual finger and hand exerciser.

8. A method for forming callused skin on a fingertip comprising the steps of:
providing a hand exerciser with individual independent finger grips;
adding an exposed upper surface area on top of said finger grips, said surface area having raised ridges and grooves transecting said ridges to simulate a string of a stringed instrument;
depressing at least one fingertip against said upper surface area when exercising said individual independent finger grips;
creating a ridged area on a fingertip when the fingertip contacts said raised ridges with grooves; and
generating a callused area on said ridged area of a fingertip by repeatedly depressing at least one finger against said upper surface area.

9. The method of claim 8, and further comprising the step of:
maintaining said callused area on said fingertip through continuous use of said hand exerciser with said upper surface area.

10. The method of claim 8, said upper surface area further comprising opposing sides extending downwardly from said upper surface area, said opposing sides culminating in a lip, said upper surface area, opposing sides and lip forming a removable cap for releasably attaching said device to said exerciser, said cap forming the contact area for a fingertip.

11. The method of claim 8, wherein said upper surface area further comprises opposing sides extending downwardly from said upper surface area forming a cap, said cap forming the contact area for a fingertip of said individual finger grips of said exerciser.

12. A device for generating callused skin on the fingertip for use in conjunction with a combination individual finger and entire hand exerciser, the device comprising:
a cap having an exposed upper surface area;
opposing sides extending downwardly from said upper surface area; and
a lip extending inwardly from one edge of said opposing sides;
said upper surface area comprising at least one raised ridge extending the length of said upper surface area, said ridge further comprising a groove transecting the width of said ridge and forming a crest extending the length of said ridge and simulating a string of a stringed instrument;
said upper surface area of said cap further comprising opposing sides extending downwardly from said upper surface area, said cap forming the contact area for a fingertip of said combination individual finger and hand exerciser.

13. A device for generating callused skin on the fingertip, said device comprising:
a hand held grip suitable for physical manipulation and placement in the palm of a human hand, said grip comprising a smooth face that rests against the palm, and
an exposed upper surface area joined to and opposing said smooth face, said upper surface area having a raised ridge extending over at least a portion of the length of said upper surface area, said ridge further comprising a groove transecting said ridge and forming at least one crest extending perpendicular to the length of said ridge and simulating a string of a stringed instrument.

14. The device of claim 13, wherein said upper surface area further comprises a raised ridge extending the width of said upper surface area, said ridge further comprising a groove transecting said ridge and forming a crest extending perpendicular to the length of said ridge and simulating a string of a stringed instrument.

15. The device of claim 14, wherein said upper surface area further comprises a first raised ridge extending the width of said upper surface area and a second raised ridge extending the length of said upper surface area and intersecting said first raised ridge to form a cross pattern along said upper surface area.

16. The device of claim 13, wherein said upper surface area and said smooth face are joined by a flexible edge.

17. A device for generating callused skin on the fingertip, said device comprising:
a hand held grip suitable for physical manipulation and placement between two fingers of a human hand, said grip comprising a smooth face that rests against at least one finger, and
an exposed upper surface area opposing said smooth face and in contacting with at the other of at least one finger of the human hand, said upper surface area having a raised ridge extending the length of said upper surface area, said ridge further comprising a groove transecting said ridge and forming a crest extending perpendicular to the length of said ridge and simulating a string of a stringed instrument.

18. The device of claim 17, wherein said upper surface area further comprises a raised ridge extending the width of said upper surface area, said ridge further comprising a groove transecting said ridge and forming a crest extending perpendicular to the length of said ridge and simulating a string of a stringed instrument.

19. The device of claim 18, wherein said upper surface area further comprises a first raised ridge extending the width of said upper surface area and a second raised ridge extending the length of said upper surface area and intersecting said first raised ridge to form a cross pattern along said upper surface area.

20. The device of claim 17, wherein said hand held grip is in the form of a guitar pick.

21. The device of claim 17, wherein said hand held grip is formed to simulate the area of a stringed instrument having a cord stretched on the instrument for striking, plucking or bowing to produce sounds.
